(19) United States
(12) Patent Application Publication
(10) Pub. No.: US 2026/0311170 A1
(43) Pub. Date: Oct. 8, 2026

(54) SETTLEMENT TERMINAL SYSTEM AND INFORMATION RELAY METHOD

(71) Applicant: NIDEC INSTRUMENTS CORPORATION, Nagano (JP)

(72) Inventor: Yosuke OGUCHI, Nagano (JP)

(21) Appl. No.: 19/463,005

(22) Filed: Jan. 28, 2026

(30) Foreign Application Priority Data
Jan. 29, 2025 (JP) 2025-012724

(51) Int. Cl. G06Q 20/38; G06Q 20/20; G06Q 20/34

(52) U.S. Cl. CPC G06Q 20/38215; G06Q 20/204; G06Q 20/34

(57) ABSTRACT

A settlement terminal system includes a settlement terminal apparatus connected to a host server and a first card information input device connected with the settlement terminal apparatus and transmitting card information to the host server through the settlement terminal apparatus. The first card information input device includes a decryption unit decrypting information encrypted by a first encryption technique, a first input part to which information is inputted by a user, and an encryption unit encrypting the information decrypted in the decryption unit by using a second encryption technique. The settlement terminal apparatus includes a first transfer unit, which transfers the information encrypted by the first encryption technique to the first card information input device, and a second transfer unit which receives the information encrypted by the second encryption technique from the first card information input device and transfers it to the host server as it is.

### CROSS REFERENCE TO RELATED APPLICATION

The present invention claims priority under 35 U.S.C. § 119 to Japanese Application No. 2025-012724 filed Jan. 29, 2025, the entire content of which is incorporated herein by reference.

### FIELD OF THE INVENTION

An embodiment of the present invention may relate to a settlement terminal system which realizes end-to-end encryption and to an information relay method in the settlement terminal system.

### BACKGROUND

When settlement is to be performed by using a card such as a credit card, card information consisting of information such as a card number, the full name of an owner and the expiration date of the card is required to be inputted to a settlement terminal apparatus such as a POS (point of sales) terminal, ATM (automated teller machine) and kiosk terminal and the card information is transmitted to a host server such as a settlement server. When card information is to be inputted to a settlement terminal apparatus, a card information input device is often used which is connected with the settlement terminal apparatus such as a POS register. A card information input device used for inputting card information includes, for example, a contact type card reader which contacts with a card and reads data from a magnetic card and an IC card, a non-contact type IC card reader which reads data from an IC card in a non-contact manner, and a PIN (Personal Identification Number) pad which is provided with button keys or the like and is used for manually inputting card information and the like. The card information inputted from a card information input device is transmitted to a host server through a settlement terminal apparatus.

Since a settlement terminal apparatus and a host server are connected with each other through a network such as the Internet and thus, in order to prevent leakage of card information, the card information is required to be encrypted and transmitted when the card information is to be transmitted from the settlement terminal apparatus to the host server. In order to secure robust security, P2PE (Point to Point Encryption) communication is often used between the settlement terminal apparatus and the host server. When P2PE communication is to be used, a card information input device is required to have a physically secure structure so as not to receive unauthorized access. Security requirements that a card information input device should be provided when P2PE communication is used is, for example, defined in PCI PTS (Payment Card Industry PIN Transaction Security) standard. A technique of encryption and decryption used for P2PE communication is referred to as a P2PE technique.

There is DUKPT (Derived Unique Key Per Transaction) as a protocol which is used when card information or the like is transmitted between a settlement terminal apparatus and a host server by P2PE communication. The DUKPT is a protocol using a common key and a protocol in which an encryption key is created by using a common seed in a transmission side and a reception side and, when the created encryption key is used once, a new encryption key is created based on the encryption key and the used encryption key is discarded. In the DUKPT, encryption is performed by point-to-point between a card information input device satisfying the PCT PTS standard and a host server. Therefore, in a case that a plurality of card information input devices is provided, for example, in a case that both of a card reader and a PIN pad are provided, a communication function by the DUKPT is required to be mounted for each card information input device. Card information encrypted according to the DUKPT is passed through a settlement terminal apparatus.

In card readers, a motor-type card reader which takes a card into a housing by driving a motor and, in this state, performs data reading from the card is unable to satisfy the PCI PTS standard due to its physical structure. In a case that a motor-type card reader is used, in order to enable transmission of card information based on the P2PE communication between a settlement terminal apparatus and a host server, Japanese Patent Laid-Open No. 2020-160713 (Patent Literature 1) discloses that an information relay device satisfying the PCT PTS standard is provided in an inside of a settlement terminal apparatus to establish a path for P2PE communication between the information relay device and the host server, and card information encrypted by master/session encryption is transmitted between the motor-type card reader and the information relay device and, after card information transmitted from the motor-type card reader is decrypted in the inside of the information relay device, the card information is encrypted by the P2PE technique and then, the encrypted card information is transmitted from the information relay device to the host server.

As described above, in a case that card information is transmitted from a settlement terminal apparatus to a host server by using P2PE communication such as DUKPT, each of card information input devices is required to satisfy a predetermined security requirement prescribed in PCI PTS standard or the like, and software for performing encryption in the P2PE technique is required to be mounted. Patent Literature 1 discloses a technique which enables use of a card information input device which does not satisfy the requirement. However, in this technique, a settlement relay device which satisfies a security requirement such as PCI PTS standard and performs P2PE communication is required to provide in an inside of a settlement terminal apparatus which is structured as a main body part of a POS terminal or the like and thus, for example, its cost is increased.

### SUMMARY

In view of the problem described above, at least an embodiment of the present invention may advantageously provide a settlement terminal system which is, without providing a special device which satisfies a security requirement such as PCI PTS standard and performs encryption processing, capable of performing settlement with a card such as a credit card by using a card information input device which does not satisfy a requirement for performing direct encryption communication with a host server, and provide an information relay method in the settlement terminal system.

According to at least an embodiment of the present invention, there may be provided a settlement terminal system which includes a settlement terminal apparatus which is capable of being connected to a host server, and a first card information input device which is connected with the settlement terminal apparatus and accepts card information and transmits the card information to the host server through the settlement terminal apparatus. The first card information input device includes a decryption unit which decrypts the card information encrypted by a first encryption technique, a first input part to which the card information is inputted by an operation of a user, and an encryption unit which encrypts the card information inputted to the first input part and the card information decrypted in the decryption unit by using a second encryption technique different from the first encryption technique. The settlement terminal apparatus includes a first transfer unit which transfers the card information encrypted by the first encryption technique to the first card information input device, and a second transfer unit which receives the card information encrypted by the second encryption technique from the first card information input device and transfers it to the host server as it is.

According to at least another embodiment of the present invention, there may be provided an information relay method which includes a settlement terminal apparatus capable of being connected to a host server and a first and a second card information input devices connected with the settlement terminal apparatus, and card information is transmitted to the host server. The information relay method includes receiving the card information in the second card information input device by an operation of a user, encrypting the card information in the second card information input device by using a first encryption technique when the card information has been received, transferring the card information encrypted by the first encryption technique to the first card information input device, decrypting the card information that has been transferred in the first card information input device, encrypting the card information by using a second encryption technique different from the first encryption technique, and transmitting the card information encrypted by using the second encryption technique to the host server through the settlement terminal apparatus.

### Effects of the Invention

According to the present invention, without providing a special device in the settlement terminal apparatus, settlement with a card such as a credit card can be performed by using a card information input device which does not satisfy a requirement for performing direct encryption communication with a host server.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram showing a configuration of a settlement terminal system in accordance with an embodiment of the present invention.

FIG. 2 is an explanatory sequence diagram showing operation of a settlement terminal system when a magnetic card or a contact type IC card is used.

FIG. 3 is an explanatory sequence diagram showing operation of a settlement terminal system when a non-contact type IC card.

FIG. 4 is an explanatory sequence diagram showing operation of a settlement terminal system when a card number is manually inputted.

### DETAILED DESCRIPTION

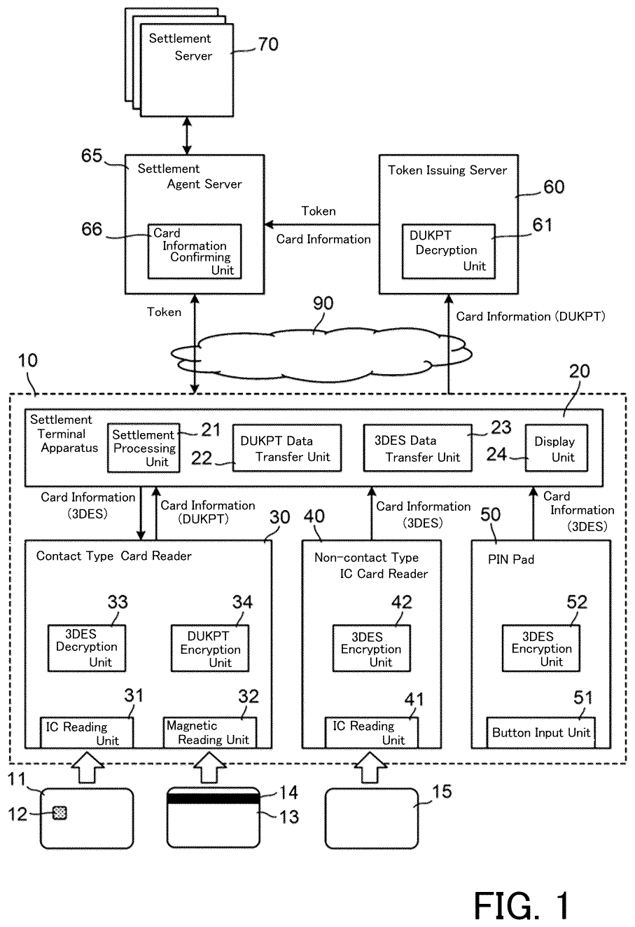

An embodiment of the present invention will be described below with reference to the accompanying drawings. FIG. 1 is a block diagram showing a configuration of a settlement terminal system in accordance with an embodiment of the present invention.

A settlement terminal system 10 shown in FIG. 1 is a system which is installed in a retail store or the like and is used to perform settlement with a card. A card used for settlement is, for example, a credit card but may be a pre-paid card, debit card, point card or the like. As a classification in a physical form, a card may be a contact type IC card 11 whose surface is formed with a contact 12, a magnetic card 13 which is formed with a magnetic stripe 14, or a non-contact type IC card 15 whose surface is not provided with a contact. In addition, a card used for settlement may be a card in which a function as a contact type IC card and a function as a magnetic card are unified into one piece, a card in which a function as a contact type IC card and a function as a non-contact type IC card are unified into one piece, and a card in which a function as a contact type IC card, a function as a non-contact type IC card and a function as a magnetic card are unified into one piece.

The settlement terminal system 10 is structured of a settlement terminal apparatus 20 which is connected to host servers through a network 90 such as the Internet to perform sales processing and settlement processing, and a contact type card reader 30, non-contact type IC card reader 40 and PIN pad 50, each of which is locally connected to the settlement terminal apparatus 20. Each of the contact type card reader 30, non-contact type IC card reader 40 and PIN pad 50 is a card information input device which accepts card information by an operation of a user. A host server is, for example, a settlement server 70 which is provided in each of credit card companies. However, it is not practical to provide a settlement terminal apparatus 20 one by one in a retail store for respective different credit card companies. Therefore, in the embodiment shown in FIG. 1, a token issuing server 60 and a settlement agent server 65 are provided as a host server to which the settlement terminal apparatus 20 is connected through the network 90. The token issuing server 60 receives an encrypted card information from the settlement terminal system 10 and decrypts it and issues a token, and the decrypted card information and the token are passed to the settlement agent server 65. The settlement agent server 65 is provided with a function distributing card information to the settlement server 70 provided for each credit card company, and the settlement agent server 65 accesses the settlement server 70 based on the card information which is sent from the token issuing server 60 and confirms the card information and then, mediates settlement between the settlement terminal apparatus 20 and the settlement server 70 by using the token which is sent from the token issuing server 60.

In this embodiment, when card information is to be transmitted from the settlement terminal system 10 to the token issuing server 60, encrypted card information is transmitted through P2PE communication. In this embodiment, DUKPT (Derived Unique Key Per Transaction) is used as an encryption protocol in P2PE communication. Therefore, the token issuing server 60 is provided with a DUKPT decryption unit 61 for decrypting the card information encrypted according to the DUKPT. The DUKPT decryption unit 61 structures an end point on a reception side in the P2PE communication. The settlement agent server 65 is provided with a card information confirming unit 66 which accesses the settlement server 70 based on card information and confirms the card information.

In this embodiment, in order to encrypt and transfer card information in an inside of the settlement terminal system 10, an encryption technique is used which is different from the encryption technique of the DUKPT. An encryption technique which is used for transfer of card information in the inside of the settlement terminal system 10 is a first encryption technique, and an encryption technique which is used in encryption for transmission of the card information between the settlement terminal system 10 and a host server is a second encryption technique. The first encryption technique and the second encryption technique are different from each other and, in this embodiment, the 3DES (Triple Data Encryption Standard) encryption is used as the first encryption technique, but other encryption techniques may be used. Normally, as the first encryption technique, a technique is used which has a smaller load of protocol processing than the second encryption technique. The above-mentioned DUKPT corresponds to the second encryption technique.

In the settlement terminal system 10, the contact type card reader 30 is locally connected to the settlement terminal apparatus 20 through a USB (Universal Serial Bus) cable or an RS-232C cable. The contact type card reader 30 is provided with an IC reading unit 31 which reads out card information from a contact type IC card 11 through a contact 12, a magnetic reading unit 32 which reads out card information recorded in a magnetic stripe 14 of a magnetic card 13, a 3DES decryption unit 33 which decrypts card information when the card information encrypted by the 3DES encryption has been transferred through the settlement terminal apparatus 20, and a DUKPT encryption unit 34 which encrypts card information according to DUKPT. The DUKPT encryption unit 34 structures an end point on a transmission side in the P2PE communication. The DUKPT encryption unit 34 performs encryption by DUKPT on both of card information read out by the IC reading unit 31 or the magnetic reading unit 32, in other words, card information received through the contact type card reader 30 by an operation of a user, and card information decrypted by the 3DES decryption unit 33, and the encrypted card information is transmitted to the token issuing server 60 through the settlement terminal apparatus 20. Since the contact type card reader 30 is provided with the DUKPT encryption unit 34, the contact type card reader 30 is structured so as to satisfy the PCI PTS standard. Each of the IC reading unit 31 and the magnetic reading unit 32 corresponds to an input unit to which card information is inputted by an operation of a user.

The non-contact type IC card reader 40 is locally connected to the settlement terminal apparatus 20 through a USB cable or an RS-232C cable, and is provided with an IC reading unit 41 which reads out card information from a non-contact type IC card 15 by short distance wireless communication (NFC: Near Field Communication), and a 3DES encryption unit 42 which encrypts card information read out by the IC reading part 41 through 3DES encryption. The card information encrypted by the 3DES encryption unit 42 is transmitted to the settlement terminal apparatus 20. The IC reading unit 41 corresponds to an input unit to which card information is inputted by an operation of a user, and the 3DES encryption unit 42 corresponds to an in-system encryption unit. The non-contact type IC card reader 40 corresponds to a second card information input device. A physical structure and the like of the non-contact type IC card reader 40 may not conform to the PCI PTS standard.

The PIN pad 50 is locally connected to the settlement terminal apparatus 20 through a USB cable or an RS-232C cable, and is provided with a button input part 51 to which a card number is inputted by a manual input, and a 3DES encryption unit 52 which encrypts card information inputted to the button input unit 51 by 3DES encryption. The card information encrypted by the 3DES encryption unit 52 is transmitted to the settlement terminal apparatus 20. The button input unit 51 corresponds to an input unit to which card information is inputted by an operation of a user, and the 3DES encryption unit 52 corresponds to an in-system encryption unit. The PIN pad 50 corresponds to a second card information input device.

The settlement terminal apparatus 20 includes a settlement processing unit 21 which performs settlement processing, a DUKPT data transfer unit 22 which receives card information encrypted by DUKPT from the contact type card reader 30 to transfer it to the token issuing server 60 as it is, a 3DES data transfer unit 23 which transfers card information, which is received from the non-contact type IC card reader 40 or the PIN pad 50 and is encrypted by 3DES encryption, to the contact type card reader 30, and a display unit 24 which displays information and the like to a user. The DUKPT data transfer unit 22 corresponds to a second transfer unit, and the 3DES data transfer unit 23 corresponds to a first transfer unit. The settlement processing unit 21 transmits card information encrypted by DUKPT to the token issuing server 60 and then, receives a token which is transmitted from the settlement agent server 65 to continuously perform settlement processing.

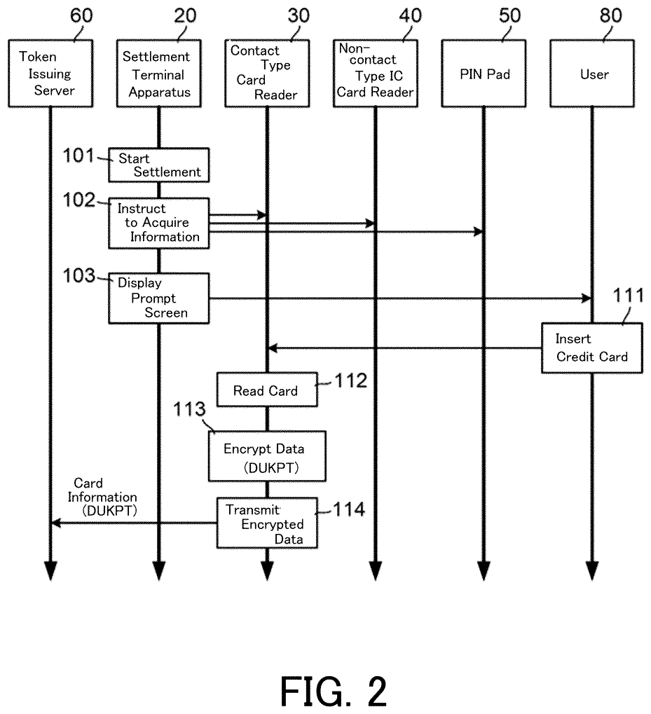

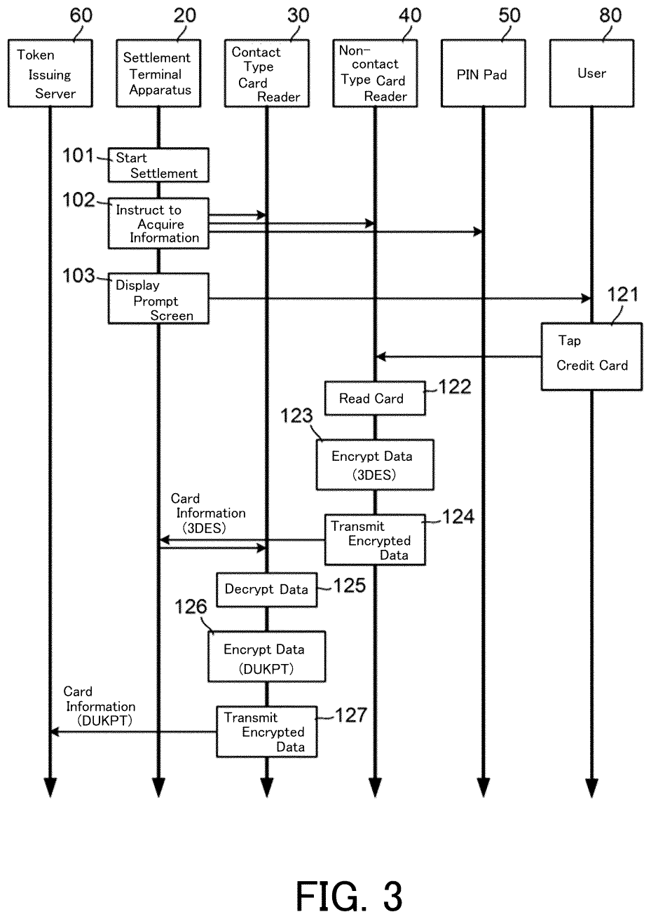

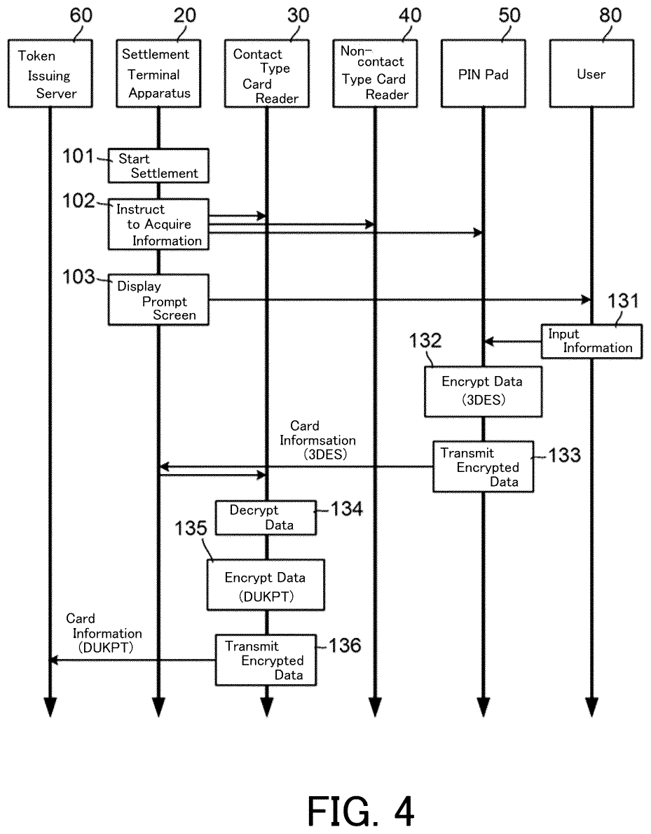

Next, an operation of the settlement terminal system 10 will be described below with reference to FIGS. 2 through 4. FIG. 2 is a sequence diagram showing an operation when a user 80 intends to perform settlement by using a contact type IC card 11 or a magnetic card 13. FIG. 3 is a sequence diagram showing an operation when a user 80 intends to perform settlement by using a non-contact type IC card 15. FIG. 4 is a sequence diagram showing an operation when a user 80 intends to perform settlement by inputting card information through the user's manual input.

As shown in FIG. 2, in a case that a user 80 intends to perform settlement by using a contact type IC card 11 or a magnetic card 13, first, settlement processing is started in the settlement terminal apparatus 20 structured as a POS register or the like (step 101). Then, in the step 102, the settlement terminal apparatus 20 instructs the contact type card reader 30, non-contact type IC card reader 40 and PIN pad 50 to acquire card information and, in the step 103, a prompt screen which prompts a user 80 to perform reading of a card or to input card information is displayed on the display unit 24 of the settlement terminal apparatus 20.

When the user 80 sees the prompt screen, in the step 111, the user 80 inserts a card to the contact type card reader 30. In a case that a card is a magnetic card 13 and the magnetic reading unit 32 of the contact type card reader 30 is in a dip-type, the user 80 dips a card in the magnetic reading unit 32. As a result, in the contact type card reader 30, reading of card information from the card is performed in the step 112, and the read card information is encrypted by the DUKPT encryption unit 34 in the step 113. The encrypted card information is transmitted from the contact type card reader 30 to the token issuing server 60 through the settlement terminal apparatus 20 in the step 114.

In a case that the user 80 intends to perform settlement by using a non-contact type IC card 15, as shown in FIG. 3, in the settlement terminal apparatus 20, similarly to the case shown in FIG. 2, settlement processing is started in the step 101. As a result, the settlement terminal apparatus 20 outputs card information acquisition instructions in the step 102, and the prompt screen is displayed in the step 103. After that, when the user 80 sees the prompt screen, in the step 121, the user 80 taps the non-contact type IC card reader 40 with a non-contact type IC card 15. As a result, in the non-contact type IC card reader 40, reading of card information is performed from the card in the step 122, and the read card information is encrypted by the 3DES encryption unit 42 in the step 123. The encrypted card information is transferred from the non-contact type IC card reader 40 to the contact type card reader 30 through the settlement terminal apparatus 20 in the step 124. In the contact type card reader 30, in the step 125, the transferred card information is decrypted by the 3DES decryption unit 33 and then, the decrypted card information is encrypted by the DUKPT encryption unit 34 in the step 126. The encrypted card information is, in the step 127, transmitted from the contact type card reader 30 to the token issuing server 60 through the settlement terminal apparatus 20.

In a case that the user 80 intends to perform settlement by inputting card information with a user's manual input, as shown in FIG. 4, in the settlement terminal apparatus 20, similarly to the case shown in FIG. 2, settlement processing is started in the step 101. As a result, the settlement terminal apparatus 20 outputs card information acquisition instructions in the step 102, and the prompt screen is displayed in the step 103. After that, when the user 80 sees the prompt screen, in the step 131, card information such as a card number is inputted to the PIN pad 50. As a result, in the PIN pad 50, in the step 132, the inputted card information is encrypted by the 3DES encryption unit 52. The encrypted card information is transferred from the PIN pad 50 to the contact type card reader 30 through the settlement terminal apparatus 20 in the step 133. In the contact type card reader 30, in the step 134, the transferred card information is decrypted by the 3DES decryption unit 33 and then, the decrypted card information is encrypted by the DUKPT encryption unit 34 in the step 135. The encrypted card information is, in the step 136, transmitted from the contact type card reader 30 to the token issuing server 60 through the settlement terminal apparatus 20.

According to the embodiment described above, without incorporating a special device, which satisfies a security requirement and is capable of performing encryption by DUKPT, into a settlement terminal apparatus, card information inputted by using a card information input device which does not comply with DUKPT is capable of being encrypted by DUKPT and transmitted to a host server.

Although the present invention has been shown and described with reference to a specific embodiment, the above-mentioned technique may be structured as follows.
[1] A settlement terminal system which includes a settlement terminal apparatus which is capable of being connected to a host server, and a first card information input device which is connected with the settlement terminal apparatus and accepts card information and transmits the card information to the host server through the settlement terminal apparatus,
where the first card information input device includes a decryption unit which decrypts the card information encrypted by a first encryption technique, a first input part to which the card information is inputted by an operation of a user, and an encryption unit which encrypts the card information inputted to the first input part and the card information decrypted in the decryption unit by using a second encryption technique different from the first encryption technique, and
the settlement terminal apparatus includes a first transfer unit which transfers the card information encrypted by the first encryption technique to the first card information input device, and a second transfer unit which receives the card information encrypted by the second encryption technique from the first card information input device and transfers it to the host server as it is.
[2] The settlement terminal system described in the above-mentioned structure [1], where the first card information input device satisfies PCI PTS standard.
[3] The settlement terminal system described in the above-mentioned structure [1] or [2], where the settlement terminal system further includes a second card information input device which is connected with the settlement terminal apparatus, the second card information input device includes a second input part to which the card information is inputted by an operation of a user, and an in-system encryption unit which encrypts the card information inputted to the second input part by using the first encryption technique, and the card information encrypted by the in-system encryption unit is transmitted to the settlement terminal apparatus.
[4] The settlement terminal system described in the above-mentioned structure [3], where the second encryption technique is P2PE technique.
[5] The settlement terminal system described in the above-mentioned structure [4], where the second encryption technique is an encryption technique according to DUKPT.
[6] The settlement terminal system described in one of the above-mentioned structures [1] through [5], where the first card information input device is a contact type card reader.
[7] The settlement terminal system described in one of the above-mentioned structures [1] through [6], where the settlement terminal apparatus further includes a settlement processing unit which receives a token transmitted from the host server to perform settlement processing after the card information encrypted by the second encryption technique is transferred to the host server.
[8] An information relay method in a settlement terminal system which includes a settlement terminal apparatus capable of being connected to a host server and a first and a second card information input devices connected with the settlement terminal apparatus, and card information is transmitted to the host server, the information relay method including receiving the card information in the second card information input device by an operation of a user, encrypting the received card information in the second card information input device by using a first encryption technique, transferring the card information encrypted by the first encryption technique to the first card information input device, decrypting the card information that has been transferred in the first card information input device, encrypting the card information by using a second encryption technique different from the first encryption technique, and transmitting the card information encrypted by using the second encryption technique to the host server through the settlement terminal apparatus.
[9] The information relay method described in the above-mentioned method [8], where the card information which has been received in the first card information input device through an operation of a user is encrypted in the first card information input device by using the second encryption technique and is transmitted to the host server through the settlement terminal apparatus.
[10] The information relay method described in the above-mentioned method [8] or [9], where the second encryption technique is P2PE technique.
[11] The information relay method described in the above-mentioned method [10], where the second encryption technique is an encryption technique according to DUKPT.

According to the structure and method described in the above-mentioned [1], [8], and [9], the first card information input device which is capable of performing direct encryption communication with the host server is capable of being used as a relay point. Therefore, settlement with a card such as a credit card can be performed by using the second card information input device which is not required to satisfy a requirement for performing direct encryption communication with the host server. Especially, when the structure described in the above-mentioned [2] is adopted, further advanced security can be secured. According to the structure described in the above-mentioned [3], as an example, the second card information input device is capable of using the first card information input device as a relay.

According to the structure and method described in the above-mentioned [4] and [10], communication with further high security can be performed with the host server and, especially, according to the structure and method described in the above-mentioned [5], [6] and [11], a settlement method mainly used in current settlement of a credit card can be adapted. According to the structure described in the above-mentioned [7], after card information has been transmitted to a host server, settlement processing can be performed with high security.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A settlement terminal system comprising:
a settlement terminal apparatus which is capable of being connected to a host server; and
a first card information input device which is connected with the settlement terminal apparatus and accepts card information and transmits the card information to the host server through the settlement terminal apparatus;
wherein the first card information input device comprises:
a decryption unit which decrypts the card information encrypted by a first encryption technique;
a first input part to which the card information is inputted by an operation of a user; and
an encryption unit which encrypts the card information inputted to the first input part and the card information decrypted in the decryption unit by using a second encryption technique different from the first encryption technique; and
the settlement terminal apparatus comprises:
a first transfer unit which transfers the card information encrypted by the first encryption technique to the first card information input device; and
a second transfer unit which receives the card information encrypted by the second encryption technique from the first card information input device and transfers it to the host server as it is.

2. The settlement terminal system according to claim 1, wherein the first card information input device satisfies PCI PTS standard.

3. The settlement terminal system according to claim 1, further comprising a second card information input device which is connected with the settlement terminal apparatus,
wherein the second card information input device comprises:
a second input part to which the card information is inputted by an operation of a user; and
an in-system encryption unit which encrypts the card information inputted to the second input part by using the first encryption technique, and
the card information encrypted by the in-system encryption unit is transmitted to the settlement terminal apparatus.

4. The settlement terminal system according to claim 3, wherein the second encryption technique is P2PE technique.

5. The settlement terminal system according to claim 4, wherein the second encryption technique is an encryption technique according to DUKPT.

6. The settlement terminal system according to claim 3, wherein the first card information input device is a contact type card reader.

7. The settlement terminal system according to claim 3, wherein the settlement terminal apparatus further comprises a settlement processing unit which receives a token transmitted from the host server to perform settlement processing after the card information encrypted by the second encryption technique is transferred to the host server.

8. An information relay method in a settlement terminal system which includes a settlement terminal apparatus capable of being connected to a host server, and a first card information input device and a second card information input device which are connected with the settlement terminal apparatus, and card information is transmitted to the host server, the information relay method comprising:
receiving the card information in the second card information input device by an operation of a user;
encrypting the card information in the second card information input device by using a first encryption technique when the card information has been received;
transferring the card information encrypted by the first encryption technique to the first card information input device;
decrypting the card information that has been transferred in the first card information input device;
encrypting the card information by using a second encryption technique different from the first encryption technique; and
transmitting the card information encrypted by using the second encryption technique to the host server through the settlement terminal apparatus.

9. The information relay method according to claim 8, wherein the card information which has been received in the first card information input device through an operation of a user is encrypted in the first card information input device by using the second encryption technique and is transmitted to the host server through the settlement terminal apparatus.

10. The information relay method according to claim 8, wherein the second encryption technique is P2PE technique.

11. The information relay method according to claim 10, wherein the second encryption technique is an encryption technique according to DUKPT.

12. The settlement terminal system according to claim 2, further comprising a second card information input device which is connected with the settlement terminal apparatus,
wherein the second card information input device comprises:
a second input part to which the card information is inputted by an operation of a user; and
an in-system encryption unit which encrypts the card information inputted to the second input part by using the first encryption technique, and
the card information encrypted by the in-system encryption unit is transmitted to the settlement terminal apparatus.

13. The settlement terminal system according to claim 12, wherein the second encryption technique is P2PE technique.

14. The settlement terminal system according to claim 13, wherein the second encryption technique is an encryption technique according to DUKPT.

15. The settlement terminal system according to claim 12, wherein the first card information input device is a contact type card reader.

16. The settlement terminal system according to claim 12, wherein the settlement terminal apparatus further comprises a settlement processing unit which receives a token transmitted from the host server to perform settlement processing after the card information encrypted by the second encryption technique is transferred to the host server.

17. The information relay method according to claim 9, wherein the second encryption technique is P2PE technique.

18. The information relay method according to claim 17, wherein the second encryption technique is an encryption technique according to DUKPT.
